(19) United States
(12) Patent Application Publication
(10) Pub. No.: US 2004/0005483 A1
(43) Pub. Date: Jan. 8, 2004

(54) Perovskite manganites for use in coatings

(76) Inventor: Chhiu-Tsu Lin, Sycamore, IL (US)

Correspondence Address: KOHN & ASSOCIATES, PLLC, Suite 410, 30500 Northwestern Highway, Farmington Hills, MI, 48334, US

(21) Appl. No.: 10/383,457

(22) Filed: Mar. 7, 2003

Related U.S. Application Data
(60) Provisional application No. 60/362,786, filed on Mar. 8, 2002.
(60) Provisional application No. 60/372,999, filed on Apr. 16, 2002.

(51) Int. Cl. B32B 9/00

(52) U.S. Cl. 428/702; 427/421; 427/240; 427/430.1

(57) ABSTRACT

A film having a large thin layer, preferably of a nano-micrometer thickness, of at least one perovskite magnanite. A coating for blocking EMIs, in particular the directed energy pulses, said coating comprising at least one nanostructured perovskite manganite in an environmentally friendly carrier. A method of protecting a surface by applying coating having at least one perovskite manganite in an environmentally friendly carrier. A barrier coating having at least one perovskite manganite in an environmentally friendly carrier.

### BACKGROUND OF THE INVENTION

1. Field of the Invention

Generally, the present invention relates to manganite perovskites. More specifically, the present invention relates to films and coatings containing manganite perovskites.

2. Description of the Related Art

Simple perovskite oxides, ABO₃, have many different types of ferroic phases including ferroelectrics, antiferroelectrics, ferroelastics, ferromagnetics, antiferromagnetics, and coupled forms thereof. For B-site cations, the Cu-based oxides are high temperature superconductors (Bednorz, J. G.; Müller, K. A. Z. Phys. B.: Condens. Matter 1986, 64, 189), the Ti/Zr-based oxides are ferroelectric ceramics (Land, C. E.; Peercy, P. S. Ferroelectric 1982, 45, 25), and the Mn-based oxides are magnetoresistive materials (Wollen, E. O.; Koehler, W. C. Phys. Rev. 1955, 100, 545).

The recent discovery of large magnetoresistive effects in doped rare-earth or transition metal manganites, having the formula Ln₁₋ₓAₓMn_{1-y}B_{y}O_{3+δ} (Ln=rare earth metal such as La, Pr, Nd, A=divalent alkaline earth cation such as Ca, Sr, Ba, Pb, B=transition metal such as Cr, Fe), has sparked a renewed interest in the study of these materials over the past few years (Rao, C. N. R.; Cheetham, A. K.; Mahesh, R. Chem. Mater. 1996, 8, 2421). The common and the most substantial characteristic of the magnetoresistive materials is that their electrical resistance can be changed significantly by external influence such as temperature, magnetic field or electric field.

Due to their unusual magnetic and electronic properties, rare-earth manganites have a variety of potential applications, including magnetic storage cells for magnetoresistive random access memories (MRAM), solid electrolytes for fuel cells, and use in infrared bolometers, however, little has been done with these compounds. The manganites can provide an inexpensive and practical means of sensing magnetic fields (“Colossal Magnetoresistance not just a Load of Bolometers,” N. Mathur, Nature, vol. 390, pp. 229-231, 1997), and lead to dramatic improvements in the data density and reading speed of magnetic recording systems (“Thousand Fold Change in Resistivity in Magnetoresistive La—Ca—Mn—O Films,” S. Jin, et al., Science, vol. 264, pp. 413-415, 1994). The manganites can also become a new material for thermal or infrared detectors, and a new material for photo and X-ray detector (“Photoinduced Insulator-to-Metal Transition in a Perovskite Manganite,” K. Miyano, et al., Physical Review Letters, vol. 78, pp. 4257-4260, 1997; “An X-ray-induced Insulator-metal Transition in a Magnetoresistive Manganite,” V. Klyukhin, et al., Nature, vol. 386, pp. 313-315, 1997). Moreover, a static electric field can trigger the collapse of the insulating charge-ordered state of magnetoresistive materials to a metallic ferromagnetic state, and can thus provide a route for fabricating micrometer- or nanometer-scale electromagnets (“Current Switching of Resistive States in Magnetoresistive Manganites,” A. Asamitsu, et al., Nature, vol. 388, pp. 50-52, 1997).

Further, it would be useful to develop a coating that can also be used as a shield of electromagnetic interference (EMI) field. Increased exposure to EM fields pose an increasing health concern and are being correlated to such maladies as breast and prostate cancer, leukemia, miscarriages, and alzheimer's disease (www.advancedliving.com/beresearch.ivnu. effects of extremely low frequency—ELF, 2001). More recently, the effects of extremely low frequency (ELF) EM fields have been implicated and in some cases correlated to these and other adverse biological effects. Children appear to be more susceptible to chronic exposure to ELF. Increases in cancer, leukemia, and decreased motor skills, attention and memory are believed to be associated with ELF, especially for children living in the near field (within 20 km) of RF towers. In 1990 the EPA listed ELF as a carcinogen in the same class as PCB's, dioxin, DDT and formaldehyde. A small number of commercial EMI shields have emerged in recent years in an effort to meet this new demand (www.advancedliving.com, www.sarshield.com, www.rfsafe.com/dolphin.htm). However, none of the shields produced include perovskite manganites and further do not function sufficiently.

The widespread proliferation of electronic circuitry for communication, computation, and other purposes ultimately results in diverse electronic circuitry and personnel in close proximity. Electromagnetic compatibility (EMC, the opposite of EMI) is critical to many facets of modern life such as electronic circuits and cables, mobile radio and ignition, radio & TV broadcast, electric motors, lighting, and power lines. A more complete list of applications also includes cell phones, computers, navigation equipment (e.g., aviation), telecommunications (e.g., financial, entertainment), medical and hospital equipment (e.g., magnetic resonance imaging, pacemakers), architectural design for buildings, automotive systems, and national security issues (e.g., random terrorism or electromagnetic pulse). Further, as electronic circuitry become smaller and more sophisticated, opportunities for environmental EMI must also increase. This results in ever increasing health risks (from EMI and associated toxic substances), particularly in heavily populated areas. While EMI shielding involves an increasingly wide spectral bandwidth, the shielding of ELF fields (i.e., 60 Hz) remains especially problematic since it usually involves low impedance magnetic induction. Moreover, new materials and their processing techniques for shielding of EMI field fluctuations or directed energy pulses (e.g., due to current or voltage spikes) need to be developed.

The problem of EMI promises to continue without bound, unless kept in check. Standard shielding materials are incapable of meeting shielding demands because they are rigid and inflexible. Many of these materials (e.g., mu metal) cannot tolerate rough handling and must be carefully machined to prevent micro-crack formation due to thermal or mechanical processes. Newer commercial shield materials for electric and magnetic fields that are flexible (e.g., metal-particle dispersed fabrics or papers) have recently been developed (www.advancedliving.com, www.sarshield.com, www.rfsafe.com/dolphin.htm). The dispersed metal particles are oxidized easily in highly corrosive streams. Thus there is a rapidly growing need for new materials for better shields (i.e., shields that are cheaper, easier to manufacture, flexible, nontoxic, and more easily adapted to a wider range of applications and environments). To date, none of the shields utilize magnetoresistive materials.

Stoichiometric LaMnO₃ is a semiconductor that orders antiferromagnetically. The A-site (hole) and/or B-site (electron) doped manganites of the formula La₁₋ₓAₓMn_{1-y}B_{y}O_{3+δ} display a ferromagnetic phase that could be explained on the basis of Zener's model of double exchange (Zener, C. Phys. Rev. 1951, 82, 403-405) between pairs of Mn³⁺ and Mn⁴⁺ (i.e., a strong exchange interaction between itinerant e_{g} and localized t_{2g} electrons). The ratio of Mn³⁺ to Mn⁴⁺ within these manganites can be controlled by changing either the types of doping ions (A and B), the degree of doping levels (x and y), or oxygen content (δ). For example, a metal-insulator transition has been observed at 250 K, 298 K, 300 K, and 370 K for La_{0.67}Ca_{0.33}MnO₃, La_{0.7}Sr_{0.3}Mn_{0.93}Fe_{0.07}O₃, La_{0.83}Sr_{0.17}MnO₃, and La_{0.7}Sr_{0.3}MnO₃, respectively. (Yang, S. et al., Chem. Mater. 1998, 10, 1374-1381; Rao, C. N. et al., Chem. Mater. 1996, 8, 2421-2432; Yang, S. et al., Mat. Res. Soc. Symp. Proc. 2001, Vol. 602, pp. 263-268). This observation indicates that the magnetoresistive manganites (film deposited directly on substrates, powder dispersed in polymer or sol-gel binders and then coated on substrates, and polycrystalline particles impregnated in refractory ceramic fiber blanket) can be tuned experimentally to be either at its metallic state, its insulator state, or its metal-insulator transition, depending on the manganite compositions and operation temperature of the ceramic barriers.

While the above information is well known to those of skill in the art, the prior art of perovskite manganites has been used only in electronic applications for magnetic sensors and memories. The manganite materials for these applications are generally prepared either in single-crystals or in epitaxial films on a relatively small area of commercial device substrates. The single-crystals and epitaxial films can only be processed slowly in size and area. In contrast, the present invention uses a “deposition by aqueous acetate solution (DAAS)” technique to dip coat, spin coat, or spray coat a large area for a complex substrate structure in a short time. The combined surfactant and surface wetting agents are used to control the nanostructure and nanocoating of the film's thickness. The present invention teaches a new scale-up processing technique for the nanostructured magnetoresistive manganites for use as EMI shields and multifunctional barriers. It would therefore be useful to develop a film and/or coating capable of forming a very large thin coating (nanostructured and nanocoating) or shield and capable of impregnating blankets (papers or fabrics). It would also be useful to develop a manganite material that can be used multifunctional barriers: high temperature resistance and corrosion inhibition barriers; radar-absorbing materials (RAM) for signature reduction barriers; and EMI shield.

### SUMMARY OF THE INVENTION

According to the present invention, there is provided a film having an expansive thin layer of a least one perovskite magnanite, preferably. Also provided is a coating for blocking EMIs, said coating comprising at least one perovskite manganite in an environmentally friendly carrier. A method of protecting a surface by applying coating having at least one perovskite manganite in an environmentally friendly carrier is also provided. The present invention also provides a corrosion resistant coating having at least one perovskite manganite in an environmentally friendly carrier. The present invention also provides a scale-up processing technique for nanostructured manganites.

### BRIEF DESCRIPTION OF THE DRAWINGS

Other advantages of the present invention are readily appreciated as the same becomes better understood by reference to the following detailed description when considered in connection with the accompanying drawings wherein:

FIG. 1 is a graph showing x-ray diffractions patterns of La_{0.83}Sr_{0.17}MnO₃ powders fired at 500° C. for six hours (line a), 550° C. for six hours (line b), 600° C. for 100 minutes (line c), 900° C. for 100 minutes (line d), and 1200 ° C. for 100 minutes (line e);

FIGS. 2A and B are scanning electron micrographs of La_{0.7}Sr_{0.3}MnO₃ thin films annealed at 900° C. for 100 minutes in air, wherein FIG. 2A is on a SrTiO₃ substrate (no tilt, 60,000×) and FIG. 2B is on a sapphire substrate (300 tilt, 70,000×);

FIG. 3 is a graph showing resistivity as a function of temperature for La_{0.83}Sr_{0.17}MnO₃ prepared in air for 100 minutes at 600, 900, and 1200° C., followed by fast cooling to room temperature;

FIG. 4 is a graph showing resistivity as a function of temperature at the magnetic fields H=0, 1, 3, 5, and 7 T (field cooled option) for La_{0.83}Sr_{0.17}MnO₃ prepared at 1200° C.;

FIGS. 5A and B are graphs showing FTIR transmission spectra of La_{0.83}Sr_{0.17}MnO₃ crystallized at 1200° C. for 100 minutes, wherein FIG. 5A is recorded with a cooled sample cell and FIG. 5B is recorded using a heated sample cell;

FIG. 6 is a photograph of La_{0.7}Sr_{0.3}MnO₃ films annealed at 900° C. for 100 minutes in air wherein line A is approximately 0.1 μm film processed on a quartz tube and line B is a thick layer fabricated on a refractory ceramic fiber blanket;

FIG. 7 is a graph showing E-field measurements of EM field attenuation (in dB) versus log f (in Hz) for Ag—Ni impregnated paper, wherein line A depicts the results for a one layer paper and line B depicts the results for a two layer paper;

FIGS. 8A through F are photographs showing the results of a 100-hour salt spray (fog) test, wherein FIGS. 8A-C show the results of parts coated with an alkyd control formulation and FIGS. 8D-F show the results of parts coated with an ISPC alkyd formulation;

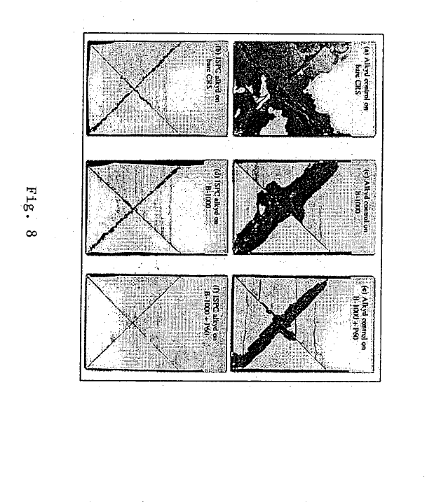

FIG. 9 is a graph showing the thermogravimetric/differential thermal analysis data for La_{0.83}Sr_{0.17}MnO₃-acetate gel precursors up to 1000° C.;

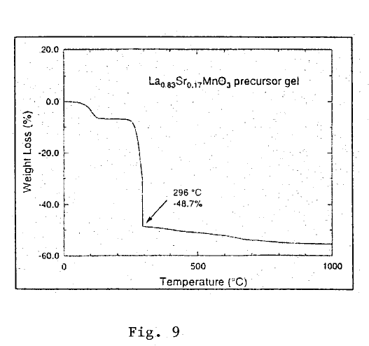

FIGS. 10A and B are a scanning electron micrograph and graph, respectively, showing the energy-dispersive X-ray (EDX) spectrum of La_{0.7}Sr_{0.}3Mn_{0.9}Fe_{0.1}O₃ powder samples annealed at 1200° C. for 100 minutes (the bar in the SEM image represents 250 μm; and

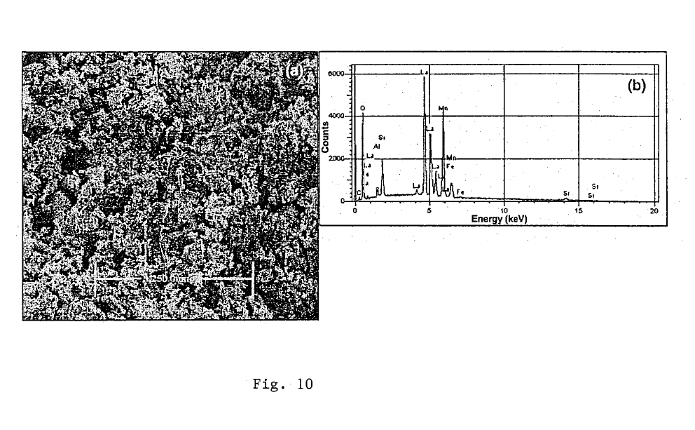

FIG. 11 is a graph showing bode-magnitude plots for panels coated with an ISPC epoxy formulation after soaking in 3% NaCl solution for ten days, line A represents the results for bare CRS, line B represents the results for a LaMnO₃ film (˜3 μm) on CRS, fired at 500° C. for one minute, line C represents the results for a LaMnO₃ film (˜3 μm) on CRS, fired at 600° C. for one minute, and line D represents the results for a LaMnO₃ film (˜3 μm) on CRS, fired at 700° C. for one minute.

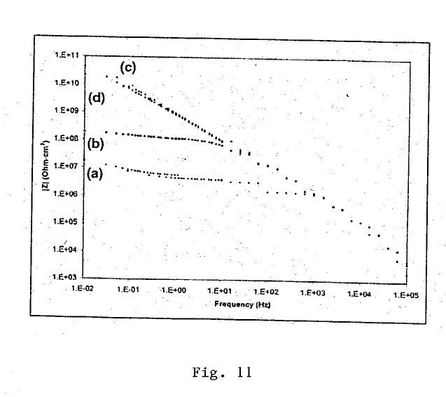

### DETAILED DESCRIPTION OF THE INVENTION

Generally, the present invention provides a coating containing perovskite manganites. More specifically, the present invention provides a thin coating that can cover expansive surface areas. Preferably, the coating contains perovskite manganites in an environmentally friendly solution. The precursor solution for coating of perovskite manganites is a 0.05-0.3 M aqueous acetate solution containing the desired stoichiometric proportions of metal acetates. A 0.5-5% of acetic acid is added to form a clear, stable, and compatible precursor solution. The 0.1-50 mM surfactants are added to form a micelle system for controlling the nanostructured of manganites. The surface wetting reagents may be needed to promote a smooth and uniform coating.

By “expansive” as used herein, it is intended to refer to extremely large surface areas. For example, the coating of the present invention can be used on automobiles, airplanes, and other large surface areas.

The perovskite manganites used in coating of the present invention can include but are not limited to, water-soluble acetates of manganese, rare earth metals, divalent alkaline earth metals, and transition metals. The preferred magnetoresistive manganites include, but are not limited to, La_{0.83}Sr_{0.17}MnO₃ (Chemistry of Materials, 10, 1374-81, 1998) and La_{0.7}Sr_{0.3}Mn_{0.93}Fe_{0.07}O₃ (Mat. Res. Soc. Symp. Proc. 602, 263-268, 2000) which have a metal-insulator transition at room temperature (˜300 K).

The environmentally friendly solution is any solution that is known to those of skill in the art to be environmentally friendly and does not contain chromate compounds. An example of such solutions includes, but is not limited to an aqueous solution.

The magnetoresistive manganites are fabricated to have a metal-insulator transition at room temperature (˜300 K). The manganites are processed by an environmentally friendly aqueous solution technique, namely “deposition by aqueous acetate solution (DAAS)” (U.S. Pat. Nos. 5,188,902 and 5,348,775). The materials can be fabricated in thin or thick films. The film is then deposited on the desired substrates (metals and dielectrics); in polycrystalline particles impregnated in and on the refractory ceramic fiber blanket; in polycrystalline powders dispersed in sol-gel and paint formulations for coating on the flexible fabrics, clothes, or papers.

Recently, an aqueous acetate solution (DAAS) technique was developed (U.S. Pat. No. 5,188,902, Feb. 23, 1993 and U.S. Pat. No. 5,348,775, Sep. 20, 1994) for making undoped and extrinsic ion-doped lead titanate (PT), lead zirconate titanate (PZT), and lead lanthanum zirconate titanate (PLZT) thin films, powders, and laser “direct write” patterns. In this invention, DAAS technique is extended to fabricate magnetoresistive manganites, Ln₁₋ₓAₓMn_{1-y}B_{y}O_{3+□} (Ln=rare earth metal such as La, Pr, Nd, A=divalent alkaline earth cation such as Ca, Sr, Ba, Pb, B=transition metal such as Cr, Fe). The chemicals used are the water-soluble acetates of manganese, rare earth metals, divalent alkaline earth metals, and transition metals. For example, for making La_{0.83}Sr_{0.17}MnO₃, about 0.05 M-0.3 M of 0.83 La/0.17Sr/1.0 Mn bulk solutions were prepared by dissolving stoichiometric amounts of metal acetates of La, Sr, and Mn in a mixture of deionized water and 10-25% acetic acid. The solution having an effective surface wetting agent was mixed ultrasonically, and the resultant clear mixture was shown to be stable (with no precipitation or gelation) for several months.

More specifically, the DAAS techniques used to prepare powders and thin films of MR manganites are described below. Lanthanum acetate hydrate, strontium acetate, and manganese acetate were dissolved in a deionized water/acetic acid mixture in the same metal ratios as desired in the final stoichiometric composition of manganite products. For the preparation of bulk powders, the precursor solution was dried under an air purge to generate a hard glassy gel. The gel was consolidated for 6 hours at 600° C. to generate a crude solid, and the solid was subsequently annealed at 600, 900, or 1200° C. for 100 minutes. For manganite film coatings, different concentrations of precursor solutions (0.03-0.3 M) were used to control the thickness of the wet film, and in turn the dry film thickness of manganites on substrates. Since the precursor solution is water-based, a small amount of surfactants (e.g., BYK 348 or Triton X-100) is generally needed to reduce surface tension and improve substrate wetting for the formation of uniform wet films. The wet films are dried at 110° C. for 10 minutes, consolidated at 500° C. for 20 minutes, and then crystallized at temperature of 900° C. to 1200° C. for 100 minutes.

In one embodiment of the present invention, magnetoresistive perovskites are used as a shield of electromagnetic interference (EMI) in general, and for against extremely low frequency (ELF) EM fields and directed energy pulses in particular. The processed EMI shields are chemically inert, thermally stable, mechanically flexible, and a more inexpensive EMI shield than those used previously.

The problem of EMI shielding is complex and encompasses numerous scientific disciplines (e.g., solid state physics, material chemistry, engineering, and electronics, to name a few). There have been numerous texts devoted to it (H. W. Ott, “Noise Reduction Techniques in Electronic Systems,” John Wiley & Sons, New York, 1988; A. Tsaliovich, “Cable Shielding for Electromagnetic Compatibility,” Van Nostrand Reinhold, New York, 1995; C. A. Paul, “Introduction to Electromagnetic Compatibility,” John Wiley & Sons, New York, 1992; T. Williams, EMC for Product Designers,” 3^{rd} edition, Oxford, Boston, 2001; M. Mardiguian, “EMI Troubleshooting Techniques,” McGraw-Hill, New York, 2001; R. Morrison, “Grounding and Shielding Techniques,” John Wiley, New York, 1998). In the simplest possible case (e.g., the near-field shielding effectiveness, S, of a uniform material in planar geometry), S can be related to bulk material properties (e.g., reduced permeability, μᵣ and conductivity, σₚ and can be expressed as,

S=A+Rₑ+Rₘ (in dB)

Here, A, Rₑ, and Rₘ represent near-field absorption, reflection for electric field, and reflection for magnetic field, respectively, in decibels. Typically, there is an additional term (B), which is a correction factor that takes into account multiple reflections from weakly absorbing layers. It is generally assumed that B term can be neglected when A exceeds ˜9 dB. Moreover, an additional correction may be necessary to represent shield materials composed of dispersed particulates.

The individual terms, A, Rₑ, and Rₘ have been calculated in the small, near-field limit at 60 Hz for materials: La_{0.83}Sr_{0.17}MnO₃, aluminum, copper, mu metal, and permalloy. In addition, estimates are given for the skin depth (δ) of the material, where δ is the depth in cm at which E and H field amplitude has been reduced to 1/e. The results indicate that while absorption (A) and reflectivity for magnetic field (Rₘ) should be negligible for La_{0.83}Sr_{0.17}MnO₃, its reflectivity for electric field (Rₑ˜220 dB), is comparable to that of Al and Cu. Furthermore, it has essentially the same (negligible) magnetic field reflectivity (Rₘ) as mu metal and permalloy. Only Al and Cu have any significant reflectivity (Rₘ) for magnetic fields, and only Mu metal and permalloy have appreciable absorption (A) (including both E and H fields). The skin depth of the material is 200 cm, 1.1 cm, 0.85 cm, 0.04 cm, and 0.07 cm for La_{0.83}Sr_{0.17}MnO₃, aluminum, copper, mu metal, and permalloy, respectively. Hence, bulk La_{0.83}Sr_{0.17}MnO₃, while having a greater skin depth, is predicted to be as effective at reflecting ELF electric fields (Rₑ) as aluminum or copper.

While EMI shielding involves an increasingly wide spectral bandwidth, the shielding of extremely low frequency (ELF) fields (i.e., 60 Hz) remains especially problematic since it usually involves low impedance magnetic induction. Conventional shield materials are rigid and inflexible. Many of these (e.g., mu metal) cannot tolerate rough handling and must be carefully machined to prevent micro-crack formation due to thermal or mechanical processes. Newer commercial shield materials for E and M fields that are flexible (e.g., metallic particles, silver or nickel, dispersed fabrics), but they are oxidized easily in highly corrosive streams. To date, none of these utilize CMR manganites, many appear environmentally unfriendly, while others appear to be lacking in scientific basis. The manganites are chemically, thermally, and mechanically stable.

Magnetoresistive materials have an important intrinsic property relevant to EMI shielding. Both μ (permeability) and σ (conductivity) increase with increasing applied magnetic field (H). This means that EMI absorption (A), scales as ˜(μσ)^{1/2}, and therefore should increase with increasing EMI field amplitude. As a result, large unsaturating fields should be attenuated more by absorption than small fields. Thus magnetoresistive materials are predicted to “react” to field increases in a way that could be particularly useful for shielding EMI field fluctuations (e.g., due to current or voltage spikes). This novel CMR property forms the key for protecting computers, electronics, C2 and SOF dedicated satellites from enemy's directed energy weapons.

The magnetoresistive ceramic perovskite La_{0.83}Sr_{0.17}MnO₃, has been evaluated for low frequency EMI shielding effectiveness and found be equivalent to aluminum or copper for reflecting ELF electric fields. Magnetoresistive shield materials are predicted to be particularly useful for shielding EMI produced by current or voltage spikes, i.e., directed energy pulses. Thus, low-cost, adaptive new shield materials (films or coatings) from dispersed magnetoresisitive manganites appear feasible.

In another embodiment of the present invention, perovskite manganites, can be used as multifunctional barriers: high temperature resistance and corrosion inhibition barriers, and radar-absorbing materials (RAM) for signature reduction barriers. A good material coating for an EMI shield is generally required to have a good adhesion to the substrates, and in turn to have good corrosion protection on vehicles. The different chemical compositions (i.e., via the variations of Ln, A, and B, and x and y) of the manganites are suitable for use as different functional barriers. The preferred manganites for use as high temperature resistance and corrosion inhibition barriers include, but are not limited to, LaMnO₃, La_{0.7}Sr_{0.3}MnO₃ (Yang, S. et al., Mat. Res. Symp. Proc. 1997, Vol. 474, 241-246), and Ca₂MnFeO₆, that contain more than one cation species and have a high oxygen-to-metal ratio. For high temperature resistance and corrosion inhibitions on metal surface, an amorphous (or polycrystalline) structure of manganite barriers is preferred. The amorphous form of manganites is flexible that displays small grain and crystallite sizes, and dense microstructures. On the other hand, the preferred manganites for use as radar-absorbing materials for signature reduction barriers include, but are not limited to, La_{0.83}Sr_{0.17}MnO₃ (Yang, S. et al., Chem. Mater., 1998, 10, 1374-1381) and La_{0.7}Sr_{0.3}Mn_{0.93}Fe_{0.07}O₃ (Yang, S. et al., Mat. Res. Symp. Proc. 2000, Vol. 602, 263-268), that have a metal-insulator transition at room temperature (˜300 K). For absorbing radiofrequency and infrared/visible wave for signature reduction applications, the good quality and highly crystalline manganites are preferred. This list is included to exemplify the forms and types of perovskite manganites that can be used. The list is not intended to be exhaustive.

All structural metals are thermodynamically unstable under ordinary conditions of temperature and pressure with respect to the formation of their oxides. Most of the oxides that offer improved corrosion resistance of metal alloys were found to contain more than one cation species and to adhere well to metallic surfaces (Stuplan, G. W. et al., Appl. Surf. Sci., 1981, 9, 250-265). In thermal barrier coatings, most of the failures depend on the process parameters, i.e., chemical composition of the surface, rapid solidification of the sprayed particles, and bond strength (Saravanan et al., Surf. Coat. Technol., 2000, 123, 44-54). The main problems of such coatings are disbanding and spalling of the coating from the substrate. Generally, MgZrO₃-based ceramics are widely used as thermal barrier coatings because of their low thermal expansion, which reduces interfacial stresses (Demirkiran, A. S. et al., Surf. Coat. Technol., 1999, 116-119, 292295). State-of-the-art thermal barrier coatings are now based on Y₂O₃-stabilized ZrO₂, due (in part) to their low thermal conductivity (approximately 1.4 Wm⁻¹K⁻¹), their good match to the thermal expansion coefficient (approximately 10⁻⁵K⁻¹) of Ni-based superalloys, and their acceptable durability during thermal cycling (Unal, O. et al., J. Am. Ceram. Soc., 1994, 77, 984-992). The formation of a Zn₂MnO₄ film on the surface coating of galvanized steels was shown to retard the cathodic reduction of dissolved oxygen (Ballote, L. D. et al., Corros. Rev. 2000, 18, 41-51).

The present invention provides fabrication technique of manganite barriers on relatively large metal sheets and complex substrates. The highly flexible manganite barriers on metallic alloys display a diffuse interfacial region that offers strongly adherent coatings for high temperature corrosion protection of metals. The amorphous manganite films contain uniform microstructures are an excellent barrier for subsequent application of organic primer and/or topcoat, giving a superior metal finish.

Further, the materials processing technique for perovskite manganites produce large area of films and/or coatings, with high throughput and low cost, for a wide range of applications and environments. The firing schedule (temperature vs. time) is used to control the formation of amorphous or crystalline structures of manganites. For the preferred amorphous manganites, LaMnO₃, for use as high temperature resistance and corrosion inhibition barriers, about 0.05 M-0.3 M of 1.0La/1.0 Mn bulk solutions was prepared by dissolving stoichiometric amounts of metal acetates of La, and Mn in a mixture of deionized water and 10-25% acetic acid. For the preferred highly crystalline manganites, La_{0.83}Sr_{0.17}MnO₃, for shielding electromagnetic interference (EMI) and use as signature reduction barriers, about 0.05M-0.3 M of 0.83 La/0.17Sr/1.0 Mn bulk solutions was prepared by dissolving stoichiometric amounts of metal acetates of La, Sr, and Mn in a mixture of deionized water and 10-25% acetic acid. These mixtures with the aid of a surface wetting agent and a flash rust inhibitor were mixed ultrasonically, and the resultant clear precursor solutions were shown to be stable (with no precipitation or gelation) for several months.

The perovskite manganites have been processed for replacing the environmentally unfriendly chromate coatings (since the chromates are carcinogenic, their uses will be restricted in the near future). In general, the oxide films that offer improved corrosion resistance are found to contain more than one cation species and have high oxygen to metal ratio, e.g., LaMnO₃, La₁₋ₓSrₓMnO₃, and Ca₂MnFeO₆. In chromate coatings, the valence of the depositing cation (Cr⁶⁺) undergoes a formal change to Cr³⁺ during film formation. In the new manganite coatings, the doping levels of Sr²⁺ and Fe³⁺ are used to modify the ratio of Mn³⁺ to Mn⁴⁺. The high temperature thermal barriers of LaMnO₃ on cold-rolled steel panels have been processed. The barriers displayed a good adhesion to steel surface and to topcoat of epoxy, polyester-melamine and polyurethane paint films. The corrosion resistance of manganite barriers is excellent as evaluated by electrochemical impedance spectroscopy and in a salt (fog) spray chamber. The manganite barriers are thermally stable of higher than 1200° C. Moreover, they are chemically inert and mechanically stable.

In the present invention of amorphous manganite coatings, LaMnO₃, for use as high temperature resistance and corrosion inhibition barriers, the formulated precursor solution is spray-coated (include thermal spray), spin-coated, roller-coated, or dip-coated on a desired metal surfaces, dried in air at 110° C., pyrolyzed at 450-550° C. and finally fired at 700-900° C. for about 0.5-5.0 minutes. Following the preparation of manganite layer on metal surface, a primer and/or topcoat organic paint is then applied. The amorphous manganite layers exhibit excellent surface adhesion on the desired metal substrates and also to the organic primers and/or topcoats, for serving as high temperature resistance and corrosion inhibition barriers that are chemically inert, thermally stable and mechanically flexible. The DMS technique generally produces a uniform film of amorphous manganites on metallic alloys. This flexible film displays small grain and crystallite sizes, and dense microstructures that can serve as excellent thermal and corrosion barriers for metal finishing. It has been shown that the fabricated manganite barriers (i.e., LaMnO₃) can effectively retard the cathodic reduction of dissolved oxygen, thus enhance the corrosion inhibition at high temperatures.

At least three known processing routes can be used to obtain the highly crystalline manganite coatings of the present invention, La_{0.83}Sr_{0.17}MnO₃, for shielding of electromagnetic interference (EMI) and use as signature reduction barriers. First, the powders of magnetoresistive manganites were prepared from the bulk precursor solution as follows. The formulated precursor solution was first dried in air at 110° C. where it was observed to undergo gelation after some initial loss of solvent, and this mixture subsequently hardened to a glassy gel. The gel was then pyrolyzed at 450-550° C. to complete decomposition and to drive the organics off the sample. Samples of the resultant powder product were then fired for about 100 minutes at 900-1200° C. The polycrystalline (highly crystalline) powders of magnetoresistive manganites are then dispersed in sol-gel and paint formulations for coating on the desired metal parts, flexible fabrics, clothes, or papers, which are then used for radar-absorbing layers. Second, the films (thin, 0.03-3 μm or thick, 3-100 μm) of magnetoresistive manganites were prepared from the bulk solution as follows. The formulated solution was spray-coated (include thermal spray), spin-coated, roller-coated, or dip-coated on a desired substrate surface, dried in air at 110° C., pyrolyzed at 450-550° C. and finally fired at 900-1200° C. for about 100 minutes. The films have excellent surface adhesion on the desired metal parts for use as radar-absorbing materials (RAM) in signature reduction applications that are chemically inert, thermally stable and mechanically flexible. Third, the polycrystalline (highly crystalline) particles of magnetoresistive manganites can also be impregnated in and on the refractory ceramic fiber blanket for EMI shielding and signature reduction applications. The refractory ceramic fiber blanket is first soaked in the formulated precursor solution, removed and dried in air at 110° C., pyrolyzed at 450-550° C. and finally fired at 900-1200° C. for about 100 minutes.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teachings provided herein.

### EXAMPLES

### Example 1

The manganite perovskites exhibit a magnetoresistive effect near the ferromagnetic ordering of manganese (Mn) spins that is accompanied by a large decrease in electrical resistivity when a dc magnetic field is applied (Physica, B155, 362, 1989). The magnetoresistive effect is usually largest near Curie temperature, T_{C} (or at metal-insulator transition temperature). The ability to fabricate a class of manganites having a metal-insulator transition temperature at 300 K offers a maximum EMI shielding capability and allows the EMI shields to be operated at room temperature without the extra cost of using additional cooling or heating devices. Magnetoresistive materials (U. Hartman, “magnetic multilayers and giant magnetoresistance: fundamentals and industrial applications”, Springer-Verlag, New York, 2000; J. A. C. Bland and B. Heinrich, “ultrathin magnetic structures I: an introduction to the electronic and magnetic structural properties”, Springer-Verlag, New York, 1994; B. Heinrich and J. A. C. Bland, “ultrathin magnetic structures II: measurement techniques and novel magnetic properties”, Springer-Verlag, New York, 1994) have an important intrinsic property relevant to EMI shielding. Both permeability and conductivity of manganite perovskites tend to increase with increasing applied magnetic field (H). This means that EMI absorption (A), scales as ˜(μσ)^{1/2}, and therefore increases with increasing EMI field amplitude. As a result, large unsaturating fields are attenuated more by absorption than small fields. Thus magnetoresistive materials react to field increases in a way that could be particularly useful for shielding EMI field fluctuations (e.g., due to current or voltage) or directed energy (electromagnetic) pulses.

The materials having a perovskite structure such as colossal magnetoresistive (CMR) materials and high temperature superconducting (HTSC) materials are important in many fields. The common and the most substantial characteristic of the CMR is that their electrical resistance can be changed significantly by external influence such as temperature, magnetic field or electric field. Due to their unusual magnetic and electronic properties, rare-earth manganites have a variety of potential applications, including magnetic storage cells for magnetoresistive random access memories (MRAM), solid electrolytes for fuel cells, and infrared bolometers. They can provide a cheap and practical means of sensing magnetic fields (“Colossal Magnetoresistance not just a Load of Bolometers,” N. Mathur, Nature, vol. 390, pp. 229-231, 1997), and lead to dramatic improvements in the data density and reading speed of magnetic recording systems (“Thousandfold Change in Resistivity in Magnetoresistive La—Ca—Mn—O Films,” S. Jin, et al., Science, vol. 264, pp. 413-415, 1994). They can also become a new material for thermal or infrared detectors, and a new material for photo and X-ray detector (“Photoinduced Insulator-to-Metal Transition in a Perovskite Manganite,” K. Miyano, et al., Physical Review Letters, vol. 78, pp. 4257-4260, 1997; “An X-ray-induced Insulator-metal Transition in a Magnetoresistive Manganite,” V. Klyukhin, et al., Nature, vol. 386, pp. 313-315, 1997). Moreover, a static electric field can trigger the collapse of the insulating charge-ordered state of CMR materials to a metallic ferromagnetic state and can provide a route for fabricating micrometer- or nanometer-scale electromagnets (“Current Switching of Resistive States in Magnetoresistive Manganites,” A. Asamitsu, et al., Nature, vol. 388, pp. 50-52, 1997).

Most exposure to environmental EMI occurs in the near-field. The field character depends on the distance from the source, consequently shielding materials respond differently to near versus far field radiation. The frequency dependence of impedance in the near-field regime is characterized by a low impedance (+slope) for magnetic fields and a high impedance (−slope) for electric fields. The free space transition region from near to far-field occurs at ˜λ/2π(λ: radiation wavelength), where the E and H impedances merge to that of the far-field (or plane wave) regime (characterized by a plane wave field impedance, Zₒ=377 Ohms). For example, the transition region of ELF from 60 Hz emissions occurs at ˜494 miles, while the transition region for a cellular phone or computer at 1 GHz is about 2 inches. Consequently, for a bandwidth of ˜1 GHz, the majority of exposure to ELF actually occurs in the near-field. Of the two types of field (electric, E or magnetic, H), it turns out that the magnetic field, which experiences the lowest impedance in the near field, is the largest problem in shielding and probably poses the greatest health risk.

Powders of magnetoresistive manganites were prepared from the bulk solution as follows. The formulated solution was first dried in air at 110° C. where it was observed to undergo gelation after some initial loss of solvent, and this mixture subsequently hardened to a glassy gel. The gel was then pyrolyzed at 450-550° C. to complete decomposition and to drive the organics off the sample. Samples of the resultant powder product were then fired for about 100 minutes at 900-1200° C. The polycrystalline powders of magnetoresistive manganites are then dispersed in sol-gel and paint formulations for coating on the flexible fabrics, clothes, or papers, which are then used for EMI shielding. Films (thin, 0.03-3 μm or thick, 3-100 μm) of magnetoresistive manganites were prepared from the bulk solution as follows. This means that a 30 nanometer (i.e., 0.03 μm) coating of manganites has been achieved by the present invention. The formulated solution was spin-coated, roller-coated, or dip-coated on a desired substrate surface, dried in air at 110° C., pyrolyzed at 450-550° C. and finally fired at 900-1200° C. for about 100 minutes. The films have excellent surface adhesion on the desired substrates for EMI shielding that are chemically inert, thermally stable and mechanically flexible. The polycrystalline particles of magnetoresistive manganites can also be impregnated in and on the refractory ceramic fiber blanket for EMI shielding. The refractory ceramic fiber blanket is first soaked in the formulated solution, removed and dried in air at 110° C., pyrolyzed at 450-550° C. and finally fired at 900-1200° C. for about 100 minutes.

To test the shielding effectiveness of magnetoresistive manganite film versus aluminum foil, copper tube and dispersed metal particles (silver-nickel impregnated paper), E-field measurements were first made of shield effectiveness (S˜A+Rₑ) for silver-nickel impregnated paper for frequency below 1 MHz to calibrate the experimental set up. A local maximum shield effectiveness of S ˜35 dB at ˜10⁴ Hz can be achieved with a single layer of ˜0.001 inch (25 micron) thick paper (fabric). At 60 Hz (and for frequencies above 1 MHz), the attenuation was S ˜15 dB. Shield effectiveness is marginally increased with additional layer of silver-nickel impregnated paper. The magnetoresistive manganite films were prepared on a quartz tube, with film thickness of ˜0.03 (30 nm), ˜0.07 (70 nm), and 0.1 μm (100 nm). The E-field measurements of shield effectiveness were made for these manganite films and the results were compared to those of a ˜25 μm thickness of copper tube, aluminum foil, and silver-nickel particle-dispersed paper. The same attenuation can be achieved for a ˜0.03 μm manganite film (one layer) for frequency below 1 kHz, a ˜0.07 μm manganite film (two layers) for frequency below 10 kHz, and a ˜0.1 μm manganite film (three layers) for frequency below 100 kHz. Following this extrapolation, a ˜0.2-0.3 μm (˜200-300 nm) manganite film (about 10 layers) should have a good coverage of EMI shielding effectiveness for frequency below 10 GHz.

CMR manganites have a metal-insulator transition temperature at ˜300 K. Examples of such CMR manganites include, but are not limited to, La_{0.83}Sr_{0.17}MnO₃ (Chem. Mater., 1998, 10, 1374) and La_{0.7}Sr_{0.3}Mn_{0.93}Fe_{0.07}O₃ (Mat. Res. Soc. Symp. Proc., 2000, 602, 263). A “Deposition by Aqueous Acetate Solution (DAAS)” technique (U.S. Pat. No. 5,188,902, Feb. 23, 1993 and U.S. Pat. No. 5,348,775, Sep. 20, 1994) was developed that is capable of fabricating a large area of CMR thin films (0.03 μm-3 μm) and thick films (3 μm˜100 μm) on metallic, semiconductor, and insulator substrates; impregnating polycrystalline manganites in the refractory ceramic fiber blanket; and dispersing CMR nanoparticles in sol-gel and paint formulations (Progress in Organic Coatings, 2001, 42, 226) for coating on the flexible fabrics, clothes, or papers. The DAAS method can process excellent quality manganites, with high throughput and low cost, for a wide range of applications and environments.

A ˜0.1 μm (˜100 nm) La_{0.83}Sr_{0.17}MnO₃ film on a quartz tube fired at 900° C. (or 1200° C.) has been prepared. The structural evolution of crystalline manganites and their transport and magnetic properties have been investigated. E-field measurements of EMI shielding effectiveness (S˜A+Rₑ) was made for the ˜0.1 μm manganite film for frequencies below 0.1 MHz. For manganites prepared at 900° C., a ˜0.1 μm CMR film performs equal to that of a ˜25 μm copper tube, aluminum foil, or silver-nickel particle-dispersed paper. For CMR manganites prepared at 1200° C., the shielding effectiveness is expected to be higher (including for EMI fields at higher frequencies of GHz ranges).

Instrumentation and Analytical Techniques

X-ray scans were undertaken on the manganites using a Rigaku D/Max-2200 vertical diffractometer with the diffraction patterns being recorded at 0.04 degree steps using Cu Kα radiation. Electrical resistivity measurements were conducted using a standard four-point technique in the temperature range 10-350 K. Magnetoresistance (Rₕ) was recorded using a Quantum Design Physical Properties Measurement System with a 7 Tesla superconducting magnet. EDX measurements were carried out at 20 keV using a Cambridge Instruments scanning electron microscope equipped with an Oxford Instruments ISIS energy dispersive X-ray analyzer.

FTIR spectra were recorded with a Bruker Vector 22 FTIR spectrometer equipped with a Cryotherm variable temperature cell obtained from International Crystal Laboratories. The ESR measurements of the perovskite manganites were conducted with an IBM ER-200D X-band spectrometer equipped with a TE 102 rectangular cavity.

Two 10 cm copper wires are assembled in parallel with a gap of ˜1 cm for inserting and testing the EMI shield. Each wire is soldered to a BNC cable, one cable is connected to the source of the EM field (an HP 8660 A synthesized signal generator) and the other is connected to the probe (A Tektronix TDS 320 two channel oscilloscope). The E-field measurements of EMI shielding effectiveness are plotted in field attenuation (in dB) vs. log f (in Hz).

Results and Discussion

Crystal Structure and Film Morphology

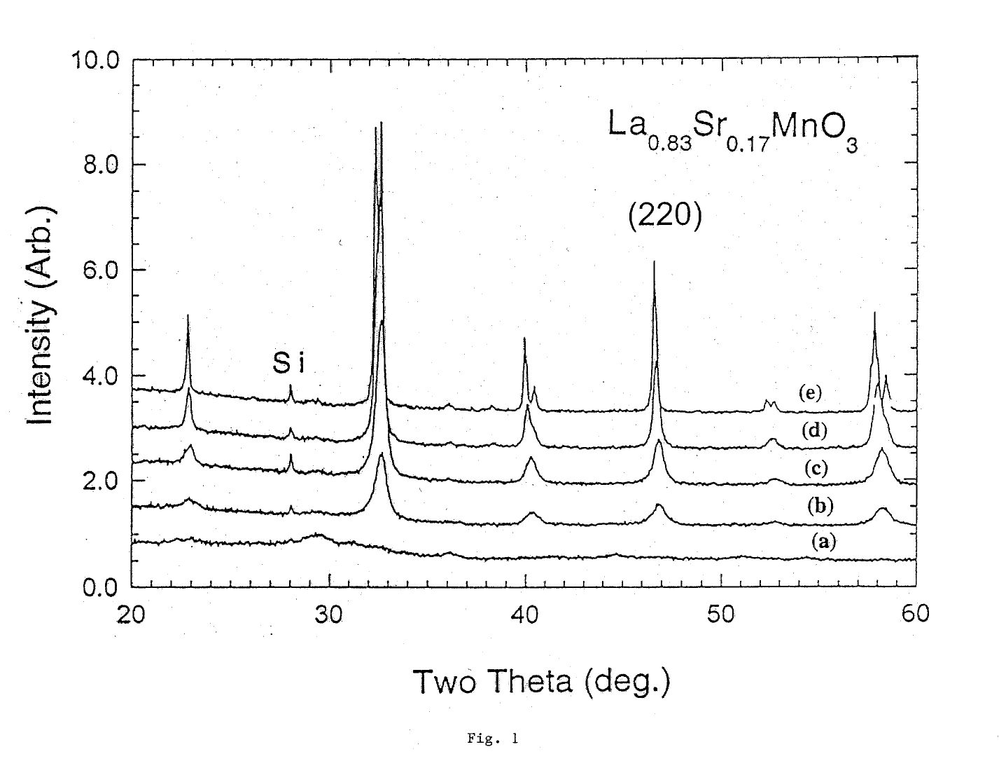

Nanoscale (nanoparticle and nanograin) manganites can give a thin and dense film for serving as effective functional coatings (e.g., EMI shield against directed energy pulses). FIG. 1 illustrates the XRD patterns of La_{0.83}Sr_{0.17}MnO₃ powders prepared by the DAAS technique as a function of firing temperature. For an annealing schedule of 500° C. for 6 hours, the resultant manganite powders are purely amorphous as shown by the XRD pattern in spectrum 1a. However, when the powder was annealed at 550° C. for 6 hours the XRD pattern (spectrum 1b) displays distinct crystalline peaks that are similar to, but slightly broader, than those observed for powders annealed at 600° C. for 100 mm (spectrum 1c). This indicates that some crystallinity of La_{0.83}Sr_{0.17}MnO₃ powder can be achieved at annealing temperatures as low as 550° C. To isolate the influence of temperature alone on the development of La_{0.83}Sr._{0.17}MnO₃ perovskite crystallinity, powder samples were annealed at 600, 900, and 1200° C. at a constant annealing time of 100 mm. As the temperature increased from 600° C. (spectrum 1c) to 900° C. (spectrum 1d) the intensities of the XRD peaks increased, the full width at half maxima (FWHM) of the XRD peaks began to narrow, some peaks began to develop shoulders, and the peaks shifted slightly to lower 20. With an annealing temperature of 1200° C. (spectrum 1e), the X-ray peaks continued to narrow and many of the reflections became well-resolved doublets (or triplets). Peak shift, combined with doublet formation normally observed for rhombohedral structure, potentially indicates the formation of a new crystalline phase of La_{0.83}Sr_{0.17}MnO₃ species at low annealing temperatures. The effects of temperature on the crystal structure transformation can be more clearly seen in expanded views of the selected X-ray reflections. The FWHM of the XRD reflections is related to both crystallite size and non-uniform strain. If the effects of non-uniform strain can be assumed to be minimal, the Scherrer equation (corrected for instrumental broadening) can be used to calculate the crystallite size. The crystallite sizes for the La_{0.83}Sr_{0.17}MnO₃ powders annealed at 600, 900, and 1200° C. (at a fixed firing time of 100 min.) were calculated from the expanded views of the (220) reflection since it does not undergo broadening and splitting during the monoclinic transformation. The nanocrystallite sizes calculated for La_{0.83}Sr_{0.17}MnO₃ powders annealed at 600, 900, and 1200° C. were 16, 41.5, and 330 nm, respectively. Using the DAAS technique, the bulk EDX analysis for La_{0.83}Sr_{0.17}MnO₃ powders compare very well with the target composition of the sample.

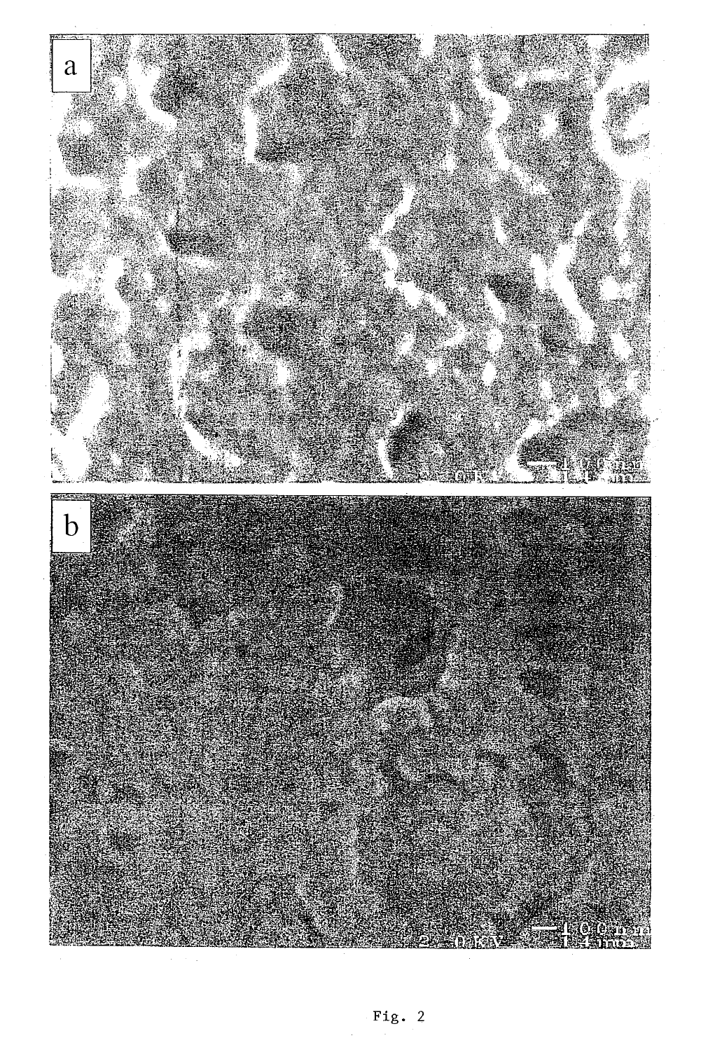

High quality and large area thin films (covering the entire area of substrates and parts) of MR manganites on quartz, silicon, sapphire, and SrTiO₃ substrates were successfully processed by the DAAS technique. MR films deposited by this technique are not epitaxial, but they are polycrystalline. The substrate appears to influence the polycrystalline structure of the MR films, as there are changes in size and shape of the MR unit cell, and different surface morphologies, on various substrates. FIG. 2 shows scanning electron micrographs of La_{0.7}Sr_{0.3}MnO₃ thin films on (a) SrTiO₃ substrate (no tilt, 60,000×) and (b) sapphire substrate (300 tilt, 70,000×) annealed at 900° C. for 100 mm in air. The grain size of polycrystalline thin films in FIG. 2 is on the order of 100 nm in diameter.

Transport and Magnetic Properties

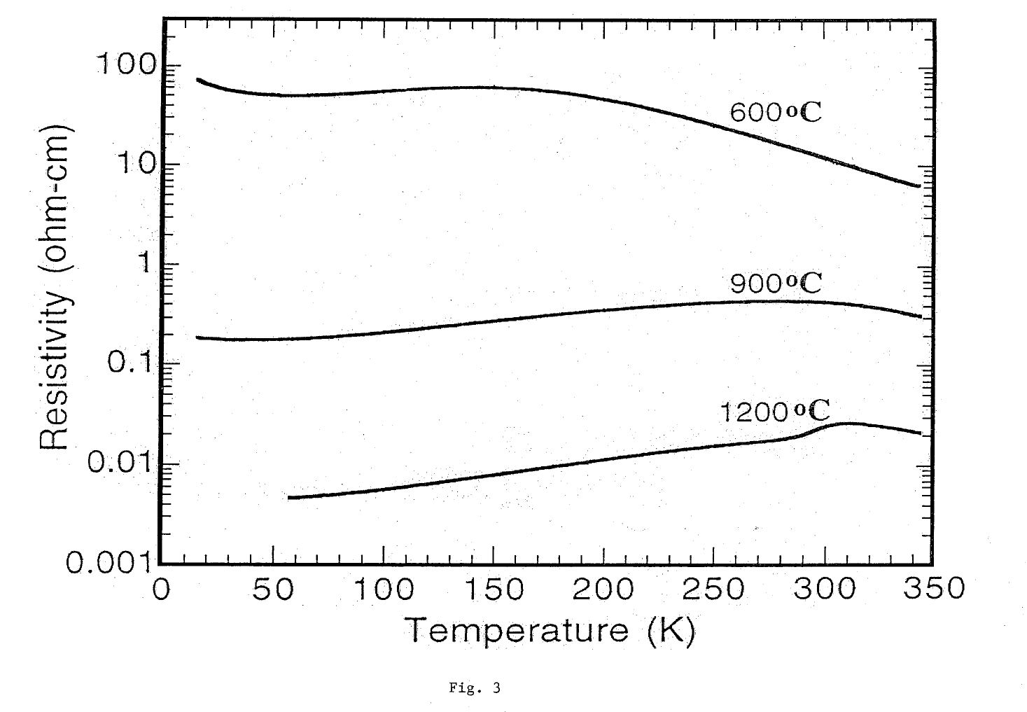

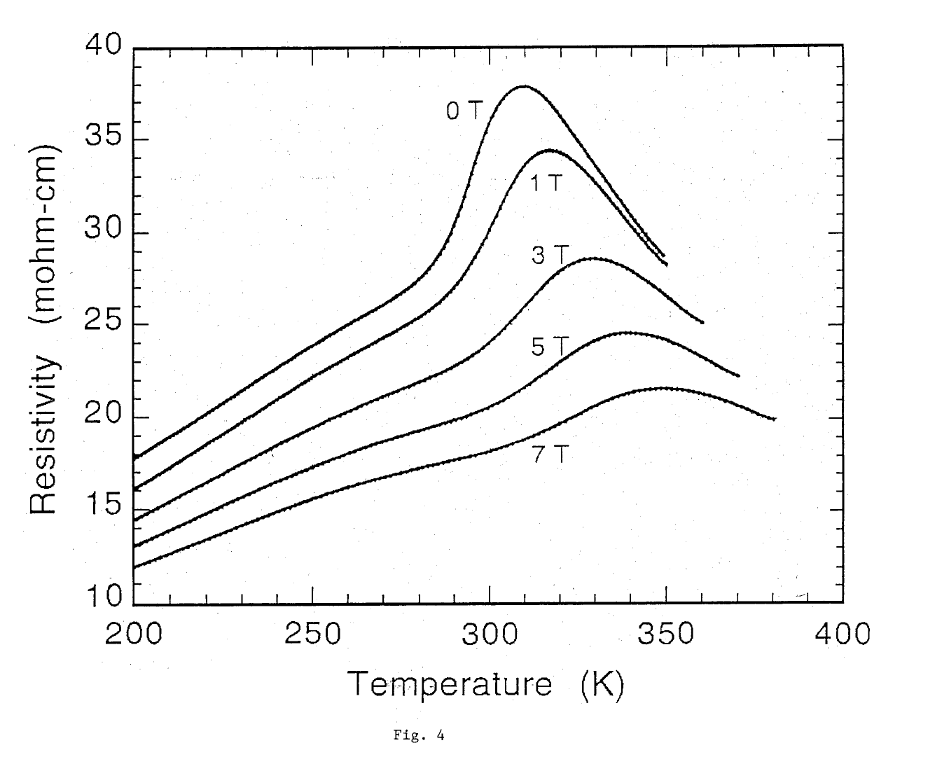

The Mn-based perovskites exhibit an MR effect near the ferromagnetic ordering of Mn spins that is accompanied by a large decrease in electrical resistivity when a dc magnetic field is applied. FIG. 3 shows the resistivity measurements for La_{0.83}Sro_{0.17}MnO₃ powders, fired at 600, 900, and 1200° C. in air for 100 min, followed by fast cooling to room temperature. Samples display large differences in both the magnitude of the resistivity and the Curie temperature, T_{c}, depending on the firing temperature. The resistivity at 350 K decreases by more than an order of magnitude for each firing at higher temperatures, i.e., R=6.0, 0.3, and 0.02 Ω·cm for firing temperature at 600, 900, and 1200° C., respectively. The data on the temperature dependence of resistivity indicate that transition to metallic state on cooling occurs at progressively higher temperatures as the firing temperature is increased. While samples fired at 600 and 900° C. show broad transitions to the metallic state at about 150 and 280 K, respectively, the sample fired at 1200° C. is very conductive and displays a sharp transition at 305 K (suitable for making an EMI shield to operate at room temperature). The magnetoresistive effect is sensitive to external influences, such as temperature, H field, and E field, thus MR manganites are an ideal barrier for shielding against EM pulses (due to current or voltage spikes). The MR effect was measured for La_{0.83}Sr_{0.17}MnO₃ powders synthesized by the DAAS method and fired at 1200° C. for 100 min. FIG. 4 shows the results for resistivity measurements performed as a function of temperature at several dc magnetic fields. The drop of the resistivity at the metal-insulator (M-I) transition is observed just below 310 K at 0 Tesla, and is shifted to higher temperatures when the magnetic field is applied (e.g., 350 K at 7 Tesla) as a result of the MR effect. The sharp decrease of the resistivity accompanied by an abrupt increase of magnetization provides evidence that in this sample the M-I and paramagnetic (PM) to ferromagnetic (FM) transitions occur simultaneously. The largest MR effect is observed around 300 K where the relative change in resistivity (Δplpₒ) is 20% with application of a 1 Tesla magnetic field.

Absorption Spectra at IR and Microwave Regions

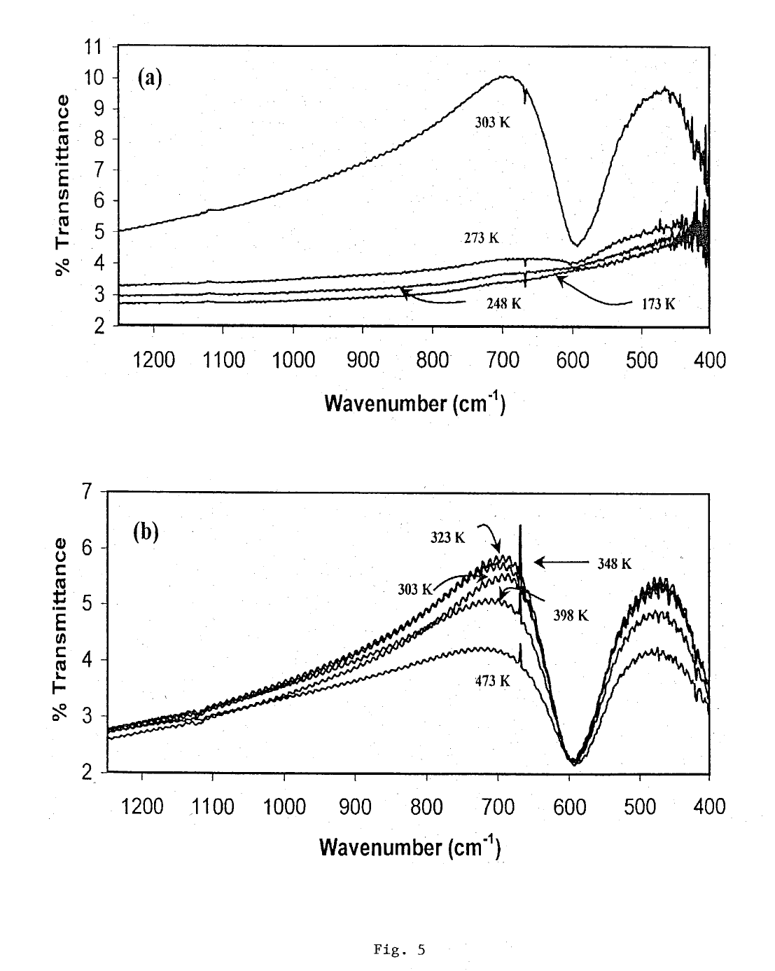

The radiation effects on MR manganites, including temperature evolution (9-300 K) and optical spectra (absorptivity, reflectivity, and conductivity) in the spectral region of 0.01-36 eV, have been investigated. The optical conductivity spectrum reveals a large spectral weight transfer with spin polarization from the interband transitions between the exchange-split lower and upper bands to the Drude-like intraband excitations within the lower up-spin band. The optical absorption spectra indicate a large coupling energy between the conduction carriers and local spins at every Mn site in manganites that exceeds the one-electron bandwidth of the conduction. FIG. 5 shows the FTIR transmission spectra of La_{0.83}Sr_{0.17}MnO₃ powders fired at 1200° C. for 100 min., (a) recorded with a cooled sample cell, and (b) recorded using a heated sample cell. An optical phonon band is observed at 590 cm⁻¹. The band corresponds with the Mn—O stretching vibrations in the MnO₆ octahedron. A strong dielectric screening effect due to free electron carriers is apparent in FIG. 5a. At 173 K, the spectral peak at 590 cm⁻¹ is almost entirely masked by the contribution of the free electron carriers, showing that La_{0.83}Sr_{0.17}MnO₃ powders display a metallic transport behavior in this temperature range. The metallic nature of La_{0.83}Sr_{0.17}MnO₃ powders is also evident by the rapid reduction of spectral transmittance at 700 cm⁻¹, when the sample cell temperature decreases from 303 K to 273 K. The insulating (or semiconductor) nature of La_{0.83}Sr_{0.17}MnO₃ powders is shown in FIG. 5b, where the spectral transmittance at 700 cm¹ decreases slowly when the sample cell is heated from 323 K to 348 K, and then to 398 K. Optical reflectance and Raman-scattering studies of manganites as a function of temperature indicate that their metal-insulator transitions can be characterized by a fundamental change from small polaron-dominated transport in the high-temperature PM phase to large-polaron (metallic) transport in the low-temperature FM phase.

ESR spectroscopy is an “indirect” structure-sensitive method that can be used to probe the atomic-scale environment of a PM center in the perovskite manganites. An intense room temperature ESR spectrum for La_{0.7}Sr_{0.3}MnO₃ powders (fired at 1200° C. for 100 mm) was recorded. It displays a g-tensor at 4.3, suggesting a fully rhombic deformation of the MnO₆ octahedra, which is in agreement with the XRD analysis.

EMI Shielding Effectiveness of Manganite Films on Quartz Tubes

The problem of EMI shielding is complex and encompasses numerous scientific disciplines. Most exposure to environmental EMI occurs in the near-field. The field character depends on the distance from the source; consequently, shielding materials respond differently to near field radiation than to far field radiation. The free space transition region from near- to far-field occurs at ˜λ/2π (λ: radiation wavelength), where the E and H impedances merge to that of the far-field (or plane wave) regime (characterized by a plane wave field impedance, Z₀ 377 Ohms). For example, the transition region of ELF from 60 Hz emissions occurs at ˜494 miles, while the transition region for a cellular phone or computer at 1 GHz is about 2 inches. Consequently, for a bandwidth of ˜1 GHz, the majority of exposure to ELF actually occurs in the near-field.

In the simplest possible case (e.g., the near-field shielding effectiveness, S, of a uniform material in planar geometry), S can be related to bulk material properties (e.g., reduced permeability, μᵣ and conductivity, σᵣ), and can be expressed as:

S=A+Rₑ+Rₘ (in db)

Here, A, Rₑ, and Rₘ represent near-field absorption, reflection for electric field, and reflection for magnetic field, respectively, in decibels. Typically, there is an additional term (B), which is a correction factor that takes into account multiple reflections from weakly absorbing layers. It is generally assumed that the B term can be neglected when A exceeds ˜9 db. Moreover, an additional correction may be necessary to represent shield materials composed of dispersed particulates.

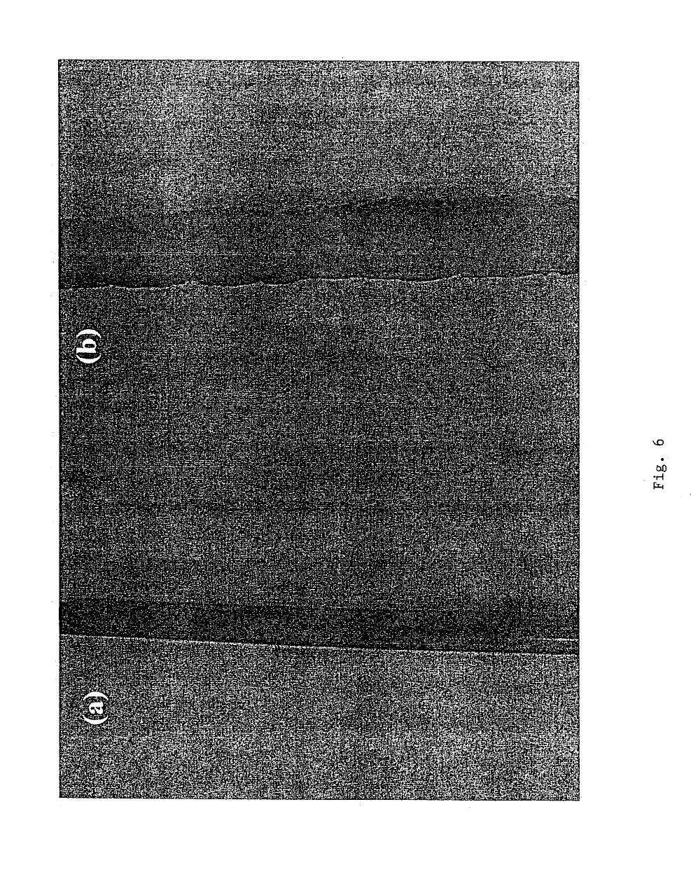

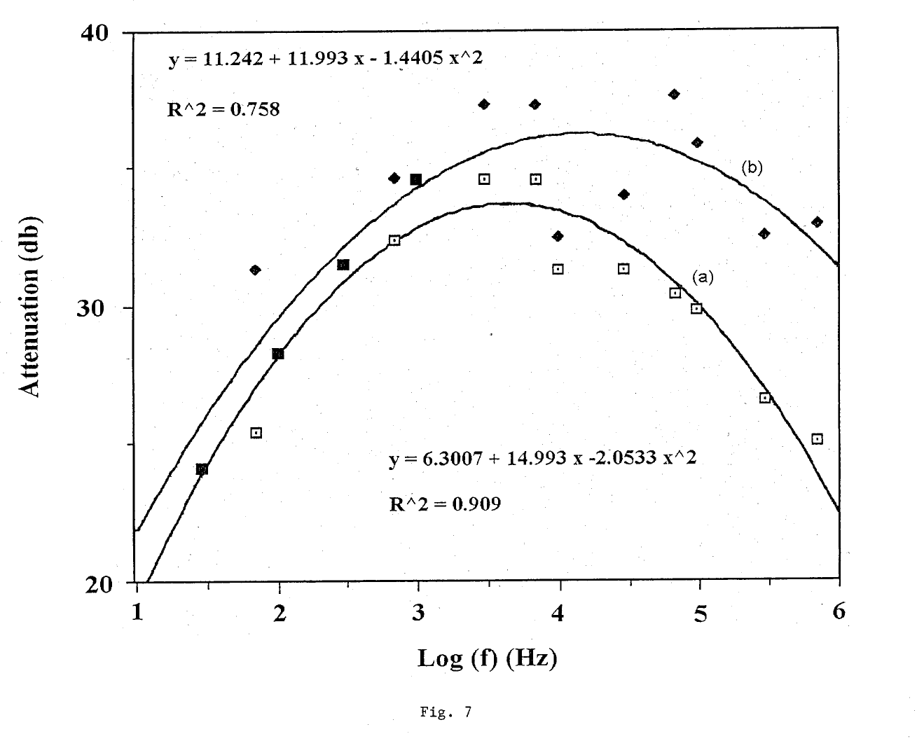

FIG. 6 shows a manganite film (˜0.1 μm or 100 nm) of La_{0.83}Sr_{0.17}MnO₃ processed on a quartz tube (a), and a layer of La_{0.83}Sr_{0.17}MnO₃ ceramic processed on a refractory ceramic fiber blanket (b). The EMI shielding effectiveness of the La_{0.83}Sr_{0.17}MnO₃ film was measured and compared to those of aluminum foil, copper tube and dispersed metal particles (silver-nickel impregnated paper). FIG. 7 shows the E-field measurements of shield effectiveness (S˜A+Rₑ) for silver-nickel impregnated paper for frequency below 1 MHz to calibrate the experimental setup. The results indicate that a local maximum shield effectiveness of S ˜35 dB at ˜10⁴ Hz can be achieved with a single layer of ˜25 μm thick Ag—Ni impregnated paper (curve 7a). At 60 Hz (and for frequencies above 1 MHz), the field attenuation was S ˜15 dB. Shield effectiveness is marginally increased with additional layers of silver-nickel impregnated paper (curve 7b). E-field measurements of shield effectiveness were made for three thicknesses of manganite films and the results were compared to those of a ˜25 μm thickness of copper tube, aluminum foil, and silver-nickel particle-dispersed paper. The same attenuation can be achieved with a ˜0.03 μm (30 nm) manganite film for frequencies below 1 kHz, a ˜0.07 μm (70 nm) manganite film for frequencies below 10 kHz, and a ˜0.1 μm (100 nm) manganite film for frequencies below 100 kHz. Following this extrapolation, a manganite film of ˜0.3 μm (300 nm) should have a good coverage of EMI shielding effectiveness for the frequency range 60 Hz-100 GHz. This manganite film is expected to be chemically inert, thermally stable, and mechanically flexible for EMI shielding against directed energy pulses. The high absorptivity of these manganites over a wide frequency range indicates that they can serve as an effective signature reduction barrier.

### CONCLUSIONS

The nanogram (and nanocrystallite size) MR manganite (La_{0.83}Sr_{0.17}MnO₃ and La_{0.7}Sr_{0.3}MnO₃) coatings have been demonstrated as effective EMI shields. A ˜100 nm grain size of manganite film and a 16-330 nm crystallite size of manganite powder have been processed. The DAAS technique can process good quality powders, films, and coatings in kilograms. The electrical resistivity and magnetization of manganites are shown to be sensitive to the temperature and applied magnetic field. The absorptivity, reflectivity, and conductivity of manganites are very active in a wide range of electromagnetic frequencies. These properties of manganites are the key factors (scientific basis) for the extra thin layer (˜0.1 μm or 100 nm) of La_{0.83}Sr_{0.17}MnO₃ needed to achieve an effective EMI shielding the same as that provided by the thick layers (˜25 μm) of copper tubing, aluminum foil, and silver-nickel particle-dispersed paper. A manganite film of ˜0.3 μm (300 nm) should have a good coverage of EMI shielding effectiveness for frequency range of 60 Hz ˜100 GHz.

### Example 2

The manganite barrier, LaMnO₃ was coated on cold-rolled steel (CRS) panels, and fired at temperatures of 500° C., 600° C., and 700° C. for 1 minute. A duplicate set was further heated, under thermal oxidation and stresses, at 350° C. for a period of an hour. The list is included to exemplify the manganite barriers that can be used. The list is not intended to be exhaustive. An epoxy primer from Niles' chemical company was applied to the above amorphous manganites treated CRS panels. The effectiveness of amorphous manganites on CRS panels as the high temperature resistance and corrosion inhibition barriers is evaluated and the results are compared to those of “standard” substrates: bare, phosphated, and chromated CRS panels. The “standard” panels are coated also with same epoxy primer. The electrochemical impedance spectroscopy (EIS) and salt (fog) spray test (ASTM B-117) were used to verify the protective performance of manganite barriers. After the coated panels being soaked in a 3% NaCl solution for 240 hours, the manganite barriers initially fired at 700° C., and followed by subjecting to a thermal stress at 350° C. for a period of an hour showed a pure capacitive behavior in EIS plots, in which the Bode-magnitude curve gave a slope of −1 throughout the frequencies measured. The AC impedance in Bode-magnitude plot at low frequency (representing the barriers of corrosion inhibition) for manganite coated panels gave a 2-4 order higher of IZI values than those of “standard” panels. The manganite coated panels are subjected to 500 hours of salt (fog) spray test. There is no observable paint film degradation for the manganite barriers prepared at 700° C., and followed by subjecting to a thermal stress at 350° C. for a period of an hour. This observation indicates that the amorphous manganites, as presented in the present invention, are the excellent barriers for high temperature resistance and corrosion inhibition.

To test the shielding effectiveness of magnetoresistive manganite film versus aluminum foil, copper tube and dispersed metal particles (silver-nickel impregnated paper), E-field measurements were first made of shield effectiveness (S˜A+Rₑ) for silver-nickel impregnated paper for frequency below 1 MHz to calibrate the experimental set up. A local maximum shield effectiveness of S ˜35 dB at ˜10 Hz can be achieved with a single layer of ˜0.001 inch (25 micron) thick paper (fabric). At 60 Hz (and for frequencies above 1 MHz), the attenuation was S ˜15 dB. Shield effectiveness is marginally increased with additional layer of silver-nickel impregnated paper. The magnetoresistive manganite films were prepared on a quartz tube, with film thickness of ˜0.03 (30 nm), ˜0.07 (70 nm), and 0.1 μm (100 nm). The E-field measurements of shield effectiveness were made for these manganite films and the results were compared to those of a ˜25 μm thickness of copper tube, aluminum foil, and silver-nickel particle-dispersed paper. The same attenuation can be achieved for a ˜0.03 μm manganite film (one layer) for frequency below 1 kHz, a ˜0.07 μm manganite film (two layers) for frequency below 10 kHz, and a ˜0.1 μm manganite film (three layers) for frequency below 100 kHz. The list is included to exemplify the E-field shield effectiveness of ceramic manganites that can be measured. The list is not intended to be exhaustive. Following the above extrapolation, a ˜0.2-0.3 μm (200-300 nm) thickness of manganite film is effective for the EMI shielding of electromagnetic frequency below 10 GHz.

There has been a growing and widespread interested in radar-absorbing material (RAM) technology that can effectively reduce radar cross-sections and electromagnetic interference. Radar-absorbing materials play a key role in the stealth technology and their use is a major factor in radar-cross-section reduction, i.e., signature reduction. The current RAMs are fabricated by aligning conductive flakes of aluminum, copper, or ferromagnetic materials (e.g., carbonyl iron, iron silicide, ferrites, and carbon) in a nonconductive binder, such as rubber or plastics (e.g., elastomers of nitrile, silicone, flouroelastomer, natural, neoprene, and hypalon). The practical RAMs depend on the materials' properties such as permeability (μ), conductivity (σ), and dielectric constant (ε), and material designs, such as impedance matching, surge impedance, and minimum length required (λ/4). In the present invention, the ceramic manganites, Ln₁₋ₓAₓMn_{1-y}B_{y}O_{3+δ}are fabricated in three forms, i.e., metallic-like conductor, semiconductor, or insulator depending on the types of doping ions (A and B), the degree of doping levels (x and y), or oxygen content (δ). Each form of ceramic manganites has a well-defined μ, σ, ε which can be changed significantly by external influence such as temperature, magnetic field (H) or electric field (E). The layer structure of RAMs of ceramic manganites can be designed and fabricated for narrow banded absorbers for EMI reduction and shielding against directed energy pulses, and for broad banded absorbers for signature reduction.

An environmentally friendly water-based materials processing technique, namely, deposition by aqueous acetate solution (DAAS) has been developed in the laboratory, to synthesize amorphous/polycrystalline thin films (˜1 μm) of undoped and extrinsic ion-doped LaMnO₃ perovskites on metallic alloys (i.e., cold-rolled steel, stainless steel, titanium, etc.). The manganite coatings on metals can be processed to have a uniform grain morphology (a grain size of 50 nm) with T-bend flexibility, and display good adhesion to both metal surface and organic primers/topcoats. For the first time, the films of ceramic perovskites have been introduced as electrical insulation, and thermal and oxidation barrier to improve the resistance to metal corrosion at high temperatures. The DAAS technique employs solely water as solvent (no volatile organic compounds as cosolvents) and safer chemicals (metal acetates of La, Mn, Sr, and Ca) as precursors, and can be easily applied (dip, spray, or flow coating) to produce homogeneous films on relatively large metal sheets and complex substrates.

Film Deposition and Formation Procedures of Manganite Barriers

Chemistry of DAAS for Manganite Films.

About 0.03-0.3 M of 1.0La/1.0 Mn (for LaMnO₃), 0.67La/0.33Ca/1.0Mn (for La_{0.67}Ca_{0.33}MnO₃), and 0.83La/0.17Sr/1.0Mn (for La_{0.83}Sr_{0.17}MnO₃) precursor solutions can be prepared by dissolving stoichiometric amounts of metal acetates of La, Mn, Sr, and/or Ca in deionized water. A small amount of acetic acid may be needed to prepare the higher concentration precursor solutions. Ranges of different concentrations can be used to control the thickness of the wet film, and subsequently the dry film thickness of manganites on metallic substrates. Since the precursor solution is a water-based formulation, a small amount of surfactant (e.g., BYK® 348 or Triton X-100) is generally needed to reduce surface tension and improve substrate wetting for the formation of uniform wet films on metallic alloys. For coatings on cold-rolled steel, a small amount of flash-rust inhibitor (e.g., Irgacor® 252 FC) is also required. The aqueous manganite solutions can be applied to the metal substrates by spray, dip, or flow coating. For this laboratory-scale study, dip coating can be employed. Substrate cleaning prior to manganite coating is essential for optimum performance. The metal coupon can be thoroughly cleaned in an industrial alkaline cleaner (e.g., in a 2% trisodium phosphate solution at 65° C. for 2 minutes), and then rinsed with water to give a water-break free surface for coating applications.

Evolution of Amorphous/Polycrystalline Manganite Films on Metallic Alloys.

A highly crystalline film of manganites on a metal surface would be too brittle, making it unsuitable as a protective barrier for metal finishing. Perovskite films with T-bend flexibility and strongly adherent to the metal surface require careful programming of the thermal curing schedule (temperature vs. time) to control the evolution of amorphous/polycrystalline film structures nucleated along the substrate structures. The thermal curing schedule is different for each chemical composition of manganite films on different metallic alloys. However, the goal is to determine the experimental conditions for synthesizing flexible manganite films with strong adhesion on metallic alloys. Desirable thin films can also have nanograin size (approximately 50 nm), nanocrystallite size (approximately 30 nm), uniform microstructures, and diffusion-like interfacial grain contacts. In this present study, three different methods were employed to follow the evolution of manganite structures and to determine the thermal curing schedules for the formation of amorphous/polycrystalline manganite films on steel, aluminum, and titanium alloys.

The first approach involves TG/DTA (Seiko 320) investigations of the thermal chemistry of manganite precursors to select processing temperatures for films. As an example, FIG. 5 displays TG/DTA data for La_{0.83}Sr_{0.17}MnO₃-acetate gel precursors up to 1000° C. When the sample is heated, the major mass loss occurs between 285 and 340 OC representing the loss of organics. There is an additional very small mass loss between 340 and 650° C. that appears to be due to the evolution of CO₂ from the manganites, as indicated by TG/FTIR analysis. Similar studies can be conducted for other manganite-acetate gel precursor compositions. The optimal processing temperatures determined for each manganite precursor composition can then be employed for making the corresponding manganite film on metal alloys.

Another approach uses FTIR spectroscopy to follow the loss of acetate and formation of Mn—O bonds: transmission FTIR spectroscopy (Bruker Vector 22) for powders, and grazing angle (Spectra Tech FT-80) FTIR for thin films. Nakamoto and coworkers have shown that the frequency separation between asymmetric and symmetric modes of the acetate group is an indication of the nature of the coordination in a related group of metal acetates. For a unidentate acetate ligand, the v_{asym} and v_{sym} vibrations of the —COO⁻ group appear at 1710 and 1280 cm⁻¹, respectively, whereas those of the corresponding bands for the bidentate acetate ligand are generally at 1562 and 1408 cm⁻¹. The ligands in metal-acetate precursors initially appear to exhibit a mixture of unidentate and bidentate cross-linked structures, but convert completely to bidentate structures as the manganite precursor samples are heated. This is indicated in the FTIR spectra by changes in the asymmetric and symmetric stretching modes of the acetate ion. The metal-oxygen bonds of the final product (perovskite manganite powder or film) are subsequently organized into a MnO₆ octahedral structure, as evidenced by the appearance of a well-defined spectral band at about 600 cm⁻¹. The preliminary studies in powder samples indicate that the La_{0.83}Sr_{0.17}MnO₃ perovskites begin to crystallize at an annealing temperature as low as 550° C. The annealing temperatures for processing manganite films (amorphous phase before a fully developed crystalline structure) on different metal substrates can be determined for differing compositions of manganite-acetate gel precursors.

The last approach uses θ-2θ X-ray powder diffraction (XRD) using a Rigaku MiniFlex diffractometer (funded by NSF CHE-9974760) to investigate the effects of temperature on the evolution of crystalline manganite films on metallic alloys. This technique was used in prior investigations on powder manganites, as shown in FIG. 2. Annealing at 500° C. for 6 hours produces La_{0.83}Sr_{0.17}MnO₃ powders that are purely amorphous, as shown by the XRD pattern in spectrum 2a. The annealing time, temperature, and the firing atmosphere, is varied to synthesize flexible manganite films with a strong adhesion on metallic alloys.

Surface Characterization and Development of a Conceptual Model for Protective Manganite Films on Metallic Alloys

The general criteria for corrosion protection of metal by a surface oxide are: low electronic conductivity, low ionic conductivity, low solubility, and proper coordination with the substrate metal. Protective oxide films (including oxides of chromium, vanadium, manganese, molybdenum, titanium, silicon, and zirconium) on aluminum and aluminum alloys have been characterized by Auger electron spectroscopy and X-ray photoelectron spectroscopy. The results indicate that these four criteria are not, in fact, independent, but do provide a useful conceptual framework. For good corrosion resistance, the deposited oxide film should have a high oxygen-to-metal ratio, and the diffuse interfacial region where both deposited metal and aluminum are observed in the Auger spectrum should form a significant fraction of the total film thickness. In this illustration, three surface analysis techniques were used to characterize the manganite films on metallic alloys. The results can be compared to those of oxide films on aluminum and aluminum alloys, and a conceptual model of protective perovskite films can be developed.

First, an RT66A standardized ferroelectric tester (Radiant Technologies, Inc.) is used to measure the electrical properties of manganite films deposited on steel, aluminum, and titanium alloys. A dry film thickness of approximately 1 μm (determined by a Dektak profilometer) for each manganite composition can be prepared and 1-mm diameter conductive silver paint electrodes can be used as electrical contacts. The capacitance and loss tangent can be measured using an impedance bridge at 1 kHz. The DC resistivity and dielectric constants of protective manganite films can be tabulated and compared. In general, low electrical conductivity is essential in a corrosion-resistant oxide. In manganite films, LaMnO₃ is an insulator. In other extrinsic ion-doped La₁₋ₓAₓMn_{1-y}B_{y}O_{3+δ} films, however, the metal-insulator transitions can be carefully controlled by changing either the types of doping ions (A and B), the degree of doping levels (x and y), or the oxygen content (δ).

Secondly, SEM-EDX measurements of manganite films on metallic alloys can be carried out at 20 keV using a Cambridge Instruments scanning electron microscope equipped with an Oxford Instruments ISIS energy-dispersive X-ray analyzer. A pure cobalt sample can be used as the calibration source for all of the quantitative measurements. This technique was used successfully in the preliminary work on electronic materials of this type. FIG. 6 shows an SEM micrograph (a) and EDX spectrum (b) of La_{0.7}Sr_{0.3}Mn_{0.9}Fe_{0.1}O₃ powder samples annealed at 1200° C. for 100 minutes. These powders, prepared by DAAS, were all found to exhibit the same general physical characteristics and to have uniform compositions and microstructures. The DAAS process produces an excellent result, in that the overall composition of a powder sample targeted to have a stoichiometry of La_{0.7}Sr_{0.3}Mn_{0.9}Fe_{0.1}O₃ was found to have an actual overall stoichiometry of La₀₇₄Sr₀₂₆(Mn₀₉₀Fe_{0.10})_{0.91}O_{3+δ}, as measured by EDX.

In the manganite films, the uniform compositions, microstructures, and thickness of the deposited barriers are essential for corrosion protection of the base metal substrates. Patchily deposited films or roughened surfaces would offer little or no corrosion protection to aluminum and titanium because both alloys corrode by a pitting mechanism. High-energy surface sites, such as sharp peaks or valleys, or thin spots in the films, would be ideal spots for corrosion pits to begin forming.

A Physical Electronics Industries 5 kV Auger electron spectrometer (Model 10-150) and a GCAIMcPherson ESCA 36 are used to analyze manganite films on metallic alloys. The analyzer system incorporates the usual multiplexer and sputter ion gun for depth profile analysis of specimens. Anodically grown Ta₂O₅ films can be profiled periodically to ensure the constancy of sputtering conditions. Several important properties of manganite films can be analyzed, such as the deposited cation species and their compositions, the oxygen-to-metal ratio in the deposited films, the formal valence of the depositing cations and their primary stable valence state, and the formation of a diffuse interfacial region. As a result of the diffuse interface, it has been shown that the lead zirconate titanate films processed on stainless steel substrates at 600° C. display an excellent surface adhesion.

The manganite barriers on metallic alloys can be used as thermal barrier coatings for high temperature corrosion protection of metals. The main problems of such coatings are debonding and spalling of coating from substrate while under thermal oxidation and stresses. The diffuse interfacial region between manganite films and metallic alloys was determined after each isothermal exposure at temperatures between 500-1100° C. in air or nitrogen atmospheres for a period of 1-24 hours. The results can be correlated with the corrosion parameters established through the electrochemical impedance measurements detailed below.

Combining ISPC Coatings with Manganite Barriers for Metal Finishing

Chrome-free single-step in-situ phosphatizing coatings (ISPCs) (U.S. Pat. No. 5,322,870, Issued Jun. 21, 1994) have been formulated and tested in the laboratory using both water-based and solvent-borne paint systems. The phosphate chemistry on the metal substrate and the coating's polymer chemistry in ISPCs are designed to take place simultaneously and independently. These reactions provide metal substrates with a good corrosion protective barrier without the need for an additional chromating step. Coupon 4f demonstrated the superior performance of the ISPC and indicated that the chemical bonds generated in ISPCs are capable of further sealing the pores of the iron phosphated and chromated panel, thus providing additional coating adhesion enhancement and substrate corrosion inhibition. Current coating practice generally involves phosphating (B-1000) and chromating (P60) cold-rolled steel substrates; aluminum and titanium alloys are pre-treated with an Alodine solution (MIL-C-5541) containing toxic chromates. An environmentally friendly manganite film can be synthesized on metallic alloys as a replacement for toxic chromate films, without loss of corrosion protection. ISPC formulations of polyester-melamine paint and epoxy/polyamide primer developed in the laboratory can first be applied to a manganite film, then the combined ISPC/manganite coatings can be tested and compared to those on chromate conversion films. This testing employs three different methods:

Water Disbanding Resistance and Cathodic Delamination.

It is commonly accepted that good adhesion between a coating and its substrate provides good corrosion protection. The manganite barriers demonstrate excellent adhesion to metallic alloys because they display a diffuse interfacial region. Manganite films have the uniform microstructures necessary to bond and interlock with ISPCs. Moreover, the ISPCs are designed to form covalent P—O—C linkages with the polymer resin and strong primary bonds with the metal (or metal alloy) surface. The more primary chemical adhesive bonds a specific coating makes with the substrate, the more resistant that system is to water disbandment. The bonding can be tested by making an X-cut through the paint film through to the substrate. Once cut, the painted coupons are immersed in a 3% NaCl solution for a predetermined soaking period, after which the specimens can be verified by ASTM method D-3359A. To test paint film disbondment resistance on metal substrates in the laboratory cathodic delamination is used. The delamination rate of an organic coating under a cathodic potential depends upon the applied potential, the electrolyte solution, and the metal substrate. Delamination testing can be conducted in a 3% NaCl solution; the painted metal substrate (cold-rolled steel, aluminum or titanium alloy) serves as a cathode and can be polarized at −900 to −1100 mV (depending on the substrate) versus a saturated calomel electrode. Both delamination area versus time and delaniination current versus time can be recorded. In general, the delamination area (πr², where r is the radius of the delaminated area) versus time for a well-protected paint film on metal substrate should follow a quadratic function.

Electrochemical Impedance Spectroscopy (EIS) and Electrical Equivalent Circuit (EEC) Analysis.

EIS data for coated coupons can be obtained using a PARC 273 potentiostat/galvanostat and a PARC 5210 lock-in amplifier (EG&G Princeton Applied Research). The experimental parameters are inputted and the data collected with the aid of EG&G electrochemical impedance software model 398. The coated panel is the working electrode and has an area of 10.0 cm² exposed to a 3% NaCl solution. Impedance measurements are carried out over the frequency range 100 kHz-10 mHz, with a 5 mV peak-to-peak sinusoidal voltage in the high frequency range (100 kHz-10 Hz). A multi-sine technique is used at lower frequencies, with an applied voltage of ±10 mV. The impedance data is taken after the coated panels have been soaked for a predetermined period.

As an example from the preliminary studies, FIG. 7 displays a Bode-magnitude plot after soaking panels coated with an ISPC epoxy formulation in a 3% salt solution for 10 days: (a) bare CRS, (b) approximately 0.3 μm LaMnO₃ film on CRS fired at 500° C. for 1 mm, (c) approximately 0.3 μm LaMnO₃film on CRS fired at 600° C. for 1 minute, and (d) approximately 0.3 μm LaMnO₃ film on CRS fired at 700° C. for 1 minute. The effect of manganite barriers on the protective performance of CRS coupons is clearly evident, in particular for the manganite films processed at 600 and 700° C. (coupons c and d).

The electrical equivalent circuits (EECs) for the impedance data collected was analyzed with the aid of the EQUIVCRT.PAS program (version 4.51), written by Bernard A. Boukamp of the University of Twente in the Netherlands. The simulated electrochemical impedance spectra can be constructed to obtain the EEC elements, including the paint film resistance, the coating capacitance, the double layer capacitance or pseudo-capacitance, and the charge-transfer resistance (R_{ct}) associated with manganite films on metallic alloys.

Salt (Fog) Spray Test

Coating corrosion resistance is assessed semiquantitatively by exposing test coupons in a salt-spray chamber following ASTM method B-117. There is an industrial type 411.1ACD, size 1, combination salt fog, CASS, acetic acid and humidity corrosion test cabinet (Industrial Filter & Pump Manufacturing Co., Illinois) installed in our paint laboratory. The chamber is operated with a 5% NaCl solution at 35° C. and 100% relative humidity. After coupons have been prepared with manganite barriers and coated with various ISPC paint formulations, they are X-cut as previously described and examined at regular intervals. Experimental coupons can be compared to a set of standard test coupons (ISPCs coated on chromated substrates). The results from all of these performance testing methods can be used to determine the film deposition and formation procedures that produce the required chemical and physical properties needed to replace the toxic chromate coatings with environmentally friendlier ceramic manganites on metallic alloys.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention can be practiced otherwise than as specifically described.

What is claimed is:

1. A film comprising an expansive thin layer of a least one perovskite magnanite

2. The film according to claim 1, wherein said perovskite manganite includes a nanostructures including nanograin, nanoparticle size, and nanothickness of a film.

3. The film according to claim 1, wherein said film includes an amount of said perovskite manganite in a range of 10-100%.

4. The film according to claim 1, wherein said perovskite manganite is selected from the group consisting essentially of soluble acetates of manganese, rare earth metals, divalent alkaline earth metals, and transition metals.

5. The film according to claim 1 for use in blocking EMIs

6. The film according to claim 5, wherein said film blocks directed energy pulses and directed energy weapons.

7. A coating composition for blocking EMIs, said coating comprising at least one perovskite manganite in an environmentally friendly carrier.

8. The coating according to claim 7, wherein said perovskite manganite is selected from the group consisting essentially of soluble acetates of manganese, rare earth metals, divalent alkaline earth metals, and transition metals.

9. The coating according to claim 7, wherein said environmentally friendly carrier is an aqueous solution that enables scaleup processing of manganites.

10. The coating according to claim 7, wherein said coating is capable of being applied to electronic devices, mechanical devices, and original equipment manufacturing parts.

11. A magnetoresistant coating comprising at least one perovskite manganite in an-environmentally friendly carrier.

12. The coating according to claim 11, wherein said perovskite manganite is selected from the group consisting essentially of soluble acetates of manganese, rare earth metals, divalent alkaline earth metals, and transition metals.

13. The coating according to claim 11, wherein said environmentally friendly carrier is an aqueous solution.

14. The coating according to claim 11, wherein said coating can be applied to a surface in need of such coating using a technique selected from the group consisting essentially of spray-coating, spin-coating, roller-coating, and dip-coating.

15. A barrier coating comprising at least one perovskite manganite in an environmentally friendly carrier.

16. The coating according to claim 15, wherein said perovskite manganite is selected from the group consisting essentially of soluble acetates of manganese, rare earth metals, divalent alkaline earth metals, and transition metals.

17. The coating according to claim 15, wherein said environmentally friendly carrier is an aqueous solution.

18. The coating according to claim 15, wherein said barrier is a selected from the group consisting essentially of a high temperature resistance barrier, a corrosion inhibition barriers, and radar-absorbing materials for signature reduction barriers.

19. A method of protecting a surface by applying a coating comprising at least one perovskite manganite in an environmentally friendly carrier.

20. The method according to claim 19, wherein said applying step includes applying the coating using a technique selected from the group consisting essentially of spray-coating, spin-coating, roller-coating, and dip-coating.

21. Electronic devices having a film as set forth in claim 1.

22. Mechanical devices having a film as set forth in claim 1.

23. OEM parts having a film as set forth in claim 1.
